(19) United States
(12) Patent Application Publication
(10) Pub. No.: US 2017/0316717 A1
(43) Pub. Date: Nov. 2, 2017

(54) Semi-wearable Device for Interpretation of Digital Content for the Visually Impaired

(71) Applicants: Abdelrazek Tarek Abdelrazek Aly, Doha (QA); Ramy Nabiel Sayed Abdulzaher, Doha (QA); Mahmoud Mohamed Mahmoud Eltouny, Doha (QA); Kariem hAmed El Badawi Abdelrehim Ahmed Fahmi, Doha (QA)

(72) Inventors: Abdelrazek Tarek Abdelrazek Aly, Doha (QA); Ramy Nabiel Sayed Abdulzaher, Doha (QA); Mahmoud Mohamed Mahmoud Eltouny, Doha (QA); Kariem hAmed El Badawi Abdelrehim Ahmed Fahmi, Doha (QA)

(21) Appl. No.: 15/499,396

(22) Filed: Apr. 27, 2017

Related U.S. Application Data
(60) Provisional application No. 62/328,026, filed on Apr. 27, 2016.

(51) Int. Cl. G09B 21/00; G06F 3/0354; G06F 3/01; G06F 3/044; A41D 19/00

(52) U.S. Cl. CPC G09B 21/004; G06F 3/044; A41D 19/00; G06F 3/014; G06F 3/0354

(57) ABSTRACT

A portable device for translation of digital content on a display into braille includes: a conductive material located adjacent an end of the portable device for contacting a display of a touchscreen device; a microcontroller located on a body of the portable device; a communications module in electronic communication with the microcontroller; and a first braille cell comprising a plurality of movable individual braille elements, the individual braille elements collectively capable of forming braille alphabet letters. The microcontroller receives a command via the communications module to create a braille character on the first braille cell in response to the conductive material contacting the display of the touchscreen device, the braille character corresponding to a character displayed on the display of the touchscreen device at the location the conductive material contacts the display.

### CROSS-REFERENCE TO RELATED APPLICATION

This application claims priority to U.S. Provisional Patent Application Ser. No. 62/328,026 for a “Portable Tactile Device for Interpreting Digital Content via Physical Representation” filed on Apr. 27, 2016, the contents of which are incorporated by reference in its entirety.

### FIELD

This disclosure relates to the field of accessibility technology. More particularly, this disclosure relates to a handheld or semi-wearable device that allows visually impaired persons to view and interpret digital content through braille language.

### BACKGROUND

Braille devices currently available to the visually impaired are either in the form of a Braille display hooked to a computer/touch surface or a Braille Note-taker, which is a Braille display with a computer built into it. The display on those two devices is a single line of 10-80 refreshable Braille cells. These devices are extremely expensive and cost between $1,000 and $15,000, with cheaper devices having as little as ten Braille cell lines, meaning a person can read ten letters or less before having to press next and move ther person's hand. These devices are also typically limited in features compared to a Tablet or a Smartphone device. The cost of these devices puts the devices well beyond the means of the vast majority of visually impaired individuals, as it is estimated that 90% of blind people live in developing countries and are therefore unable to afford the devices. Additionally, these devices are not highly portable as they are quite bulky, and the single line display is quite slower to read and less natural compared to our approach, which will provide a full-page reading capabilities with intuitive interaction.

Other devices have attempted to integrate other tactile elements. However, these devices typically require various pieces of specialized hardware and are not compatible with existing devices that already include touch screens.

What is needed, therefore, is a tactile device for interpreting content of a touchscreen or other similar device in a tactile form.

### SUMMARY

A portable device translates digital content on a display into tactile feedback. In a first aspect, the portable device includes: a conductive material located adjacent an end of the portable device for contacting a display of a touchscreen device; a microcontroller located on a body of the portable device; a communications module in electronic communication with the microcontroller; and a first braille cell comprising a plurality of movable individual braille elements, the individual braille elements collectively capable of forming braille alphabet letters. The microcontroller receives a command via the communications module to create a braille character on the first braille cell in response to the conductive material contacting the display of the touchscreen device, the braille character corresponding to a character displayed on the display of the touchscreen device at the location the conductive material contacts the display.

In one embodiment, the portable device further includes: a glove body shaped to conform to a shape of a user's hand, wherein the first braille cell is located at a first fingertip of the glove; and a second braille cell located at a second fingertip of the glove.

In another embodiment, the portable device further includes: a first pressure sensor located adjacent the first braille cell; and a second pressure sensor located adjacent the second braille cell. The first and second pressure sensors detect when the first and second fingertips of the glove contact a surface.

In a second aspect, a portable device for translation of digital content on a display into tactile feedback includes: a glove body shaped to conform to a shape of a user's hand; a conductive material located adjacent an end of the portable device for contacting a display of a touchscreen device; a microcontroller located on a body of the portable device; a communications module in electronic communication with the microcontroller; and a first braille cell located at a first fingertip of the glove shaped body and comprising a plurality of movable individual braille elements, the individual braille elements collectively capable of forming braille alphabet letters. The microcontroller receives a command via the communications module to create a braille character on the first braille cell in response to the conductive material contacting the display of the touchscreen device, the braille character corresponding to a character displayed on the display of the touchscreen device at the location the conductive material contacts the display.

In a third aspect, a method of translating digital content on a display into tactile feedback includes: providing a handheld device including a capacitive portion located on an end of the handheld device and a braille cell located on the device adjacent a finger of a user; providing a touchscreen device including a touchscreen display; contacting a portion of the touchscreen display with the capacitive portion of the handheld device; determining on the touchscreen device a location of the portion of the touchscreen display contacted by the capacitive portion of the handheld device; identifying a character displayed on the touchscreen device in the portion of the touchscreen display contacted by the handheld device; transmitting an identity of the character identified within the portion of the touchscreen display contacted by the handheld device; translating the identified character into a braille character; and generating the braille character on the braille cell of the handheld device.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1-5 show a handheld device for translating content of a display to tactile feedback according to embodiments of the present disclosure;

FIG. 6 shows a chart including characters of a braille alphabet according to one embodiment of the present disclosure;

FIGS. 7-9 show flow charts of queuing characters touched by a user with a handheld device according to embodiments of the present disclosure;

FIGS. 10 and 11 show a handheld device in a stylus form according to one embodiment of the present disclosure;

FIGS. 12 and 13 show a handheld device including rotating braille cells according to one embodiment of the present disclosure; and

FIGS. 14 and 15 show a handheld device shaped to conform to a user's hand according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

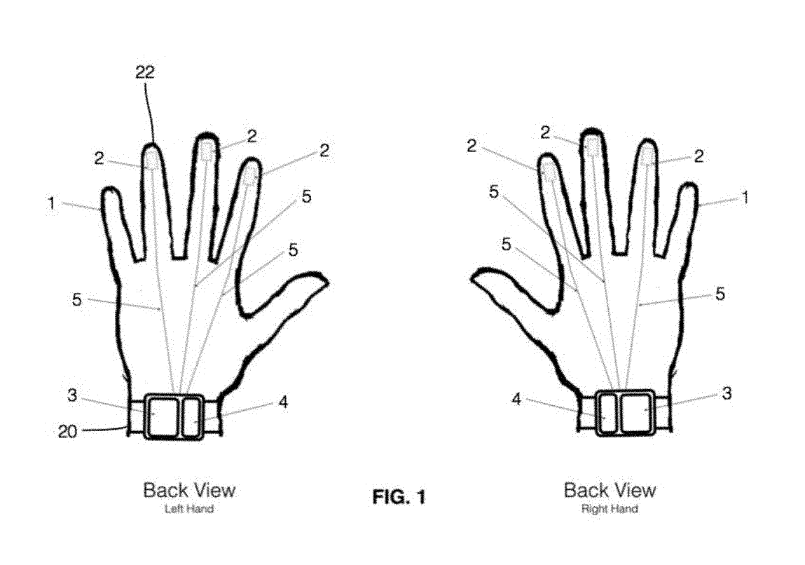

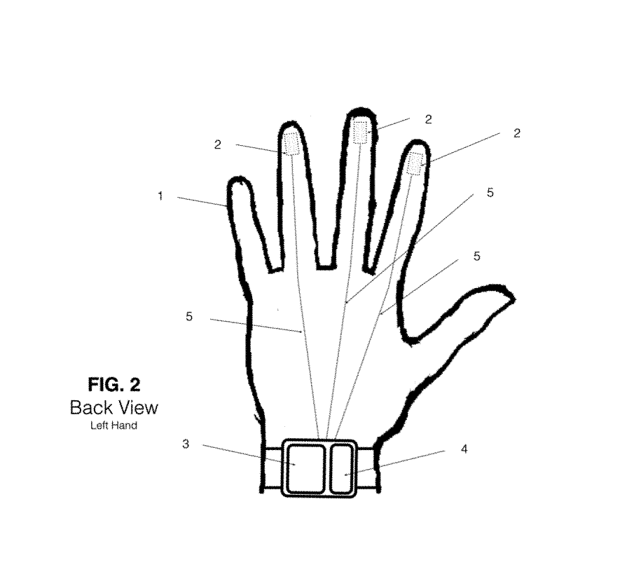

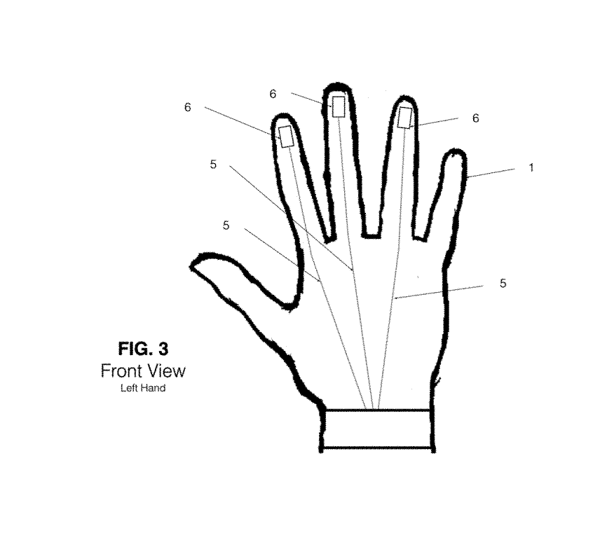

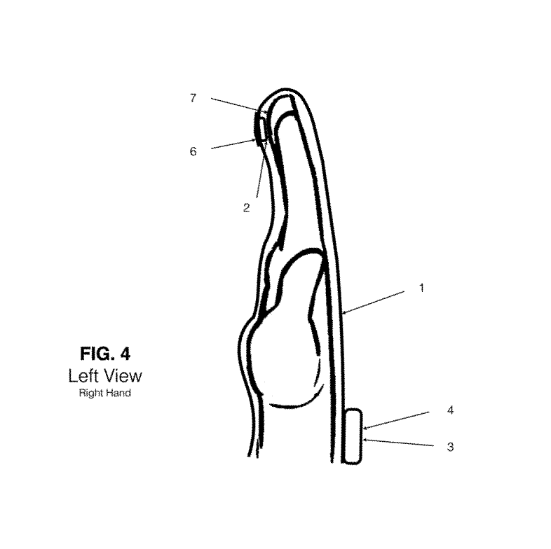

FIGS. 1-4 show a user's hands, each with its own handheld device 1, shown as a glove in FIG. 1. As referred to herein, handheld device 1 corresponds to a device that is readily grasped and manipulated by a user. The handheld device 1 may be a device that is either held in a user's grip, or may be a wearable device that is worn by a user on the user's hands. Each handheld device 1 will be identical, except for alignment of fingers, to fit either of the user's hands. Each handheld device 1 will consist of one or more braille cells 2 and one or more pressure sensors 6 that are located inside the handheld device 1 adjacent fingertips of a user, and underneath the tip of the ring, middle, and index fingers of the user. The braille cell 2 and pressure sensor 6 are in electronic communication with a microcontroller 3 via communication lines 5 extending from the braille cells 2 to a wrist band 20 the wrist band 20 including the microcontroller 3 and a power source 4 (such as a battery). The braille cells 2 are preferably located at a tip 22 of the handheld device 1 adjacent a fingertip of the user. The tip 22 of the handheld device 1 is preferably formed of a conductive material, such that a capacitive touchscreen display detects the tip 22 contacting the capacitive touchscreen display.

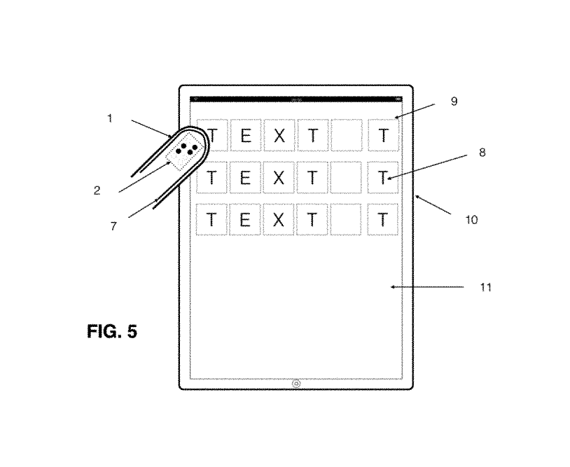

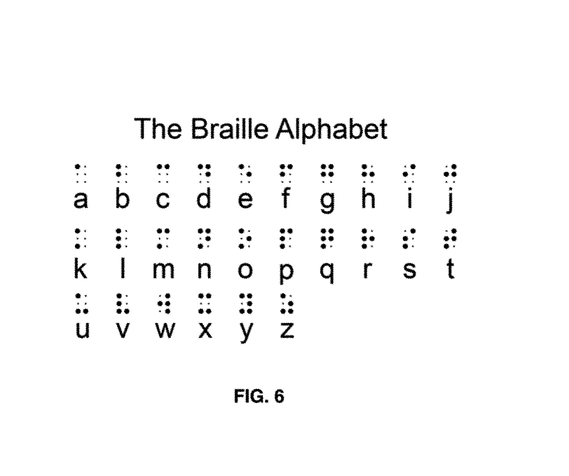

FIG. 5 is a top view of the handheld device 1 interacting with a touchscreen display 11 of a touchscreen device 10. The handheld device 1 is preferably constructed at least partially from a conductive material such that the touchscreen device 10 detects the handheld device 1 contacting the touchscreen display 11. The handheld device 1 is shown as a glove in FIGS. 1-5, and under the tip 22 of the handheld device 1, the braille cell 2 is provided that is preferably formed of piezoelectric cells that move up and down to form the braille alphabet, shown in FIG. 6, when a user's—finger touches a letter 8 on the touchscreen 11 of an exemplary touchscreen device 10. However, it is also understood that the braille cell 2 may be formed of various other suitable tactile feedback mechanisms that would allow a visually impaired user to interpret the letter 8 displayed on the touchscreen 111 of the touchscreen device 10.

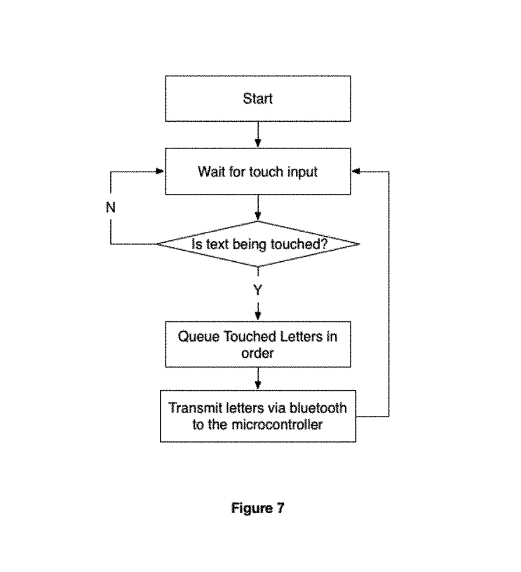

Referring now to FIG. 7, embodiments of the handheld device 1 further include programmable instructions implemented on one or more of the handheld device 1 and touchscreen device 10. Touch input from the user, such as when the user contacts the touchscreen display 11 with a conductive portion of the handheld device 1, is detected on the touchscreen display 11 by the touchscreen device 10 on the touchscreen device 10. If a letter region 9 (FIG. 5) is touched by the user, the letter 8 is added to a letter queue with other letters currently being touched. The letter queue may be stored on the microcontroller 3 of the handheld device 1.

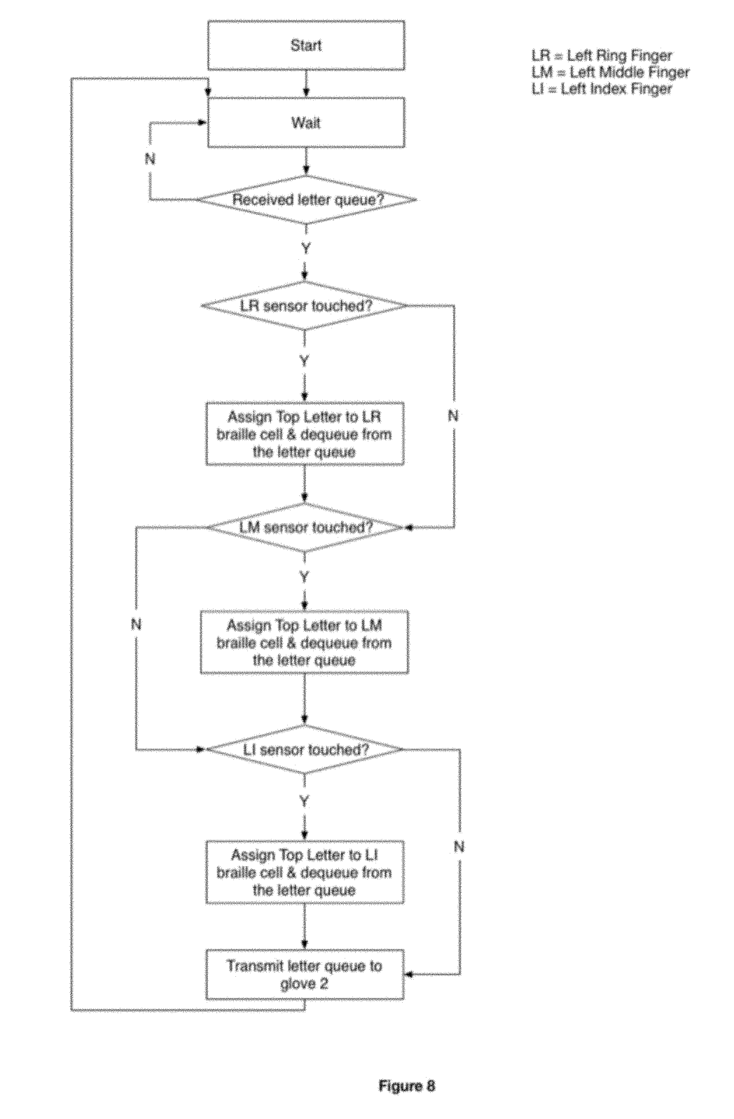

As shown in FIG. 8, touched letters are detected and queued, thereby creating a string of letters. Once received, touch sensors 6 are checked to detect if the Left Ring Finger (LR) sensor is down and if so, the first received letter in the queue is assigned to the braille cell 2 located on the left ring finger of the handheld device 1. Similarly, touch sensors 6 are check to detect if the Left Middle Finger (LM) is touched, assigning the following letter to the braille cell 2 located adjacent the Left Middle Finger if the corresponding Left Middle Finger sensor 6 is down, and then again with the left index finger and the following letter.

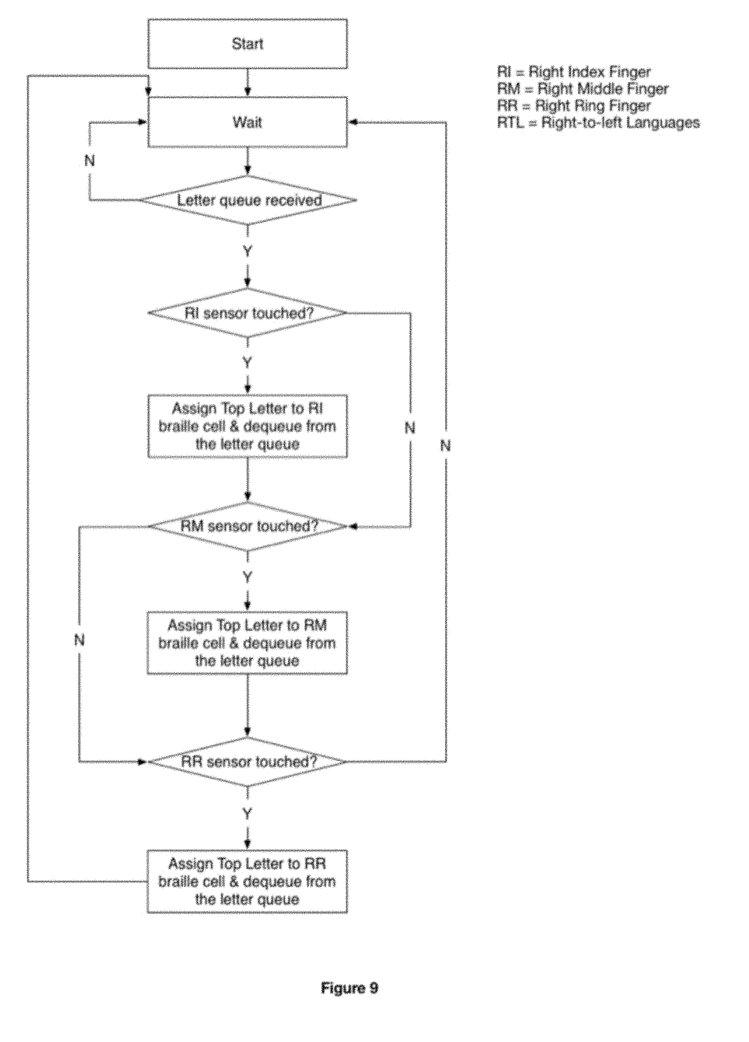

The process of queuing and assigning detected letters is further performed on the handheld device 1 on the right hand of the user, as shown in FIG. 9. The touch sensors 6 are checked for a received detected letter queue, which may include a string of letters. Afterwards, the sensors 6 are checked to determine if the Right Ring Finger (RR) sensor is down and if so, assign the first letter in the queue to it the Right Ring Finger braille cell 2. The system then performs the same with the Right Middle Finger (RM), assigning the following letter to the braille cell 2 of the Right Middle Finger if the corresponding sensor 6 is detected as in contact with a surface, and then again with the Right Index Finger (RI) and the following letter.

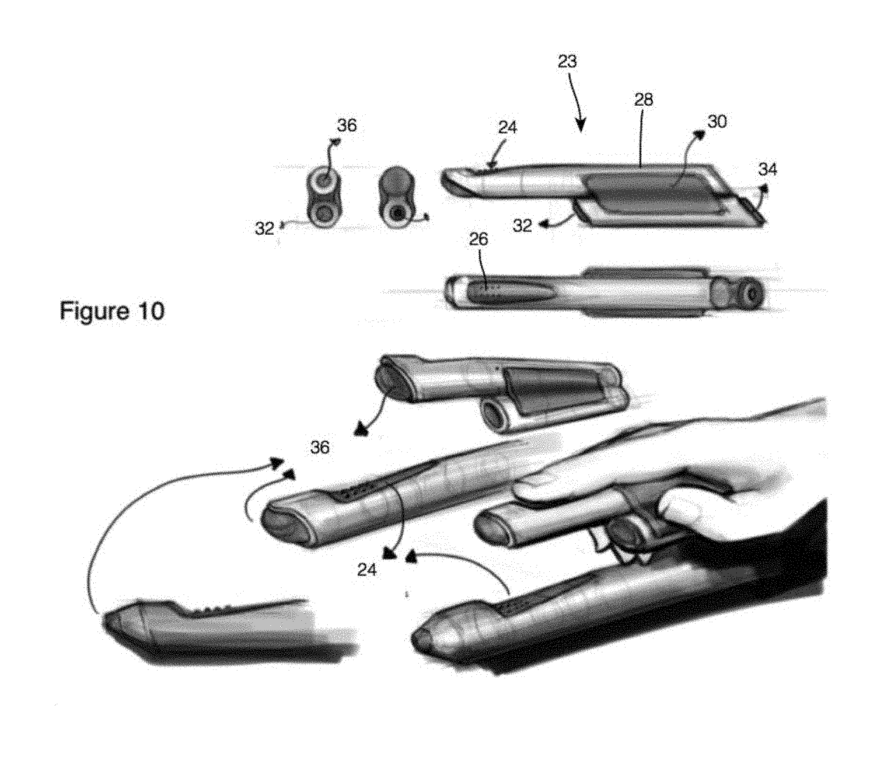

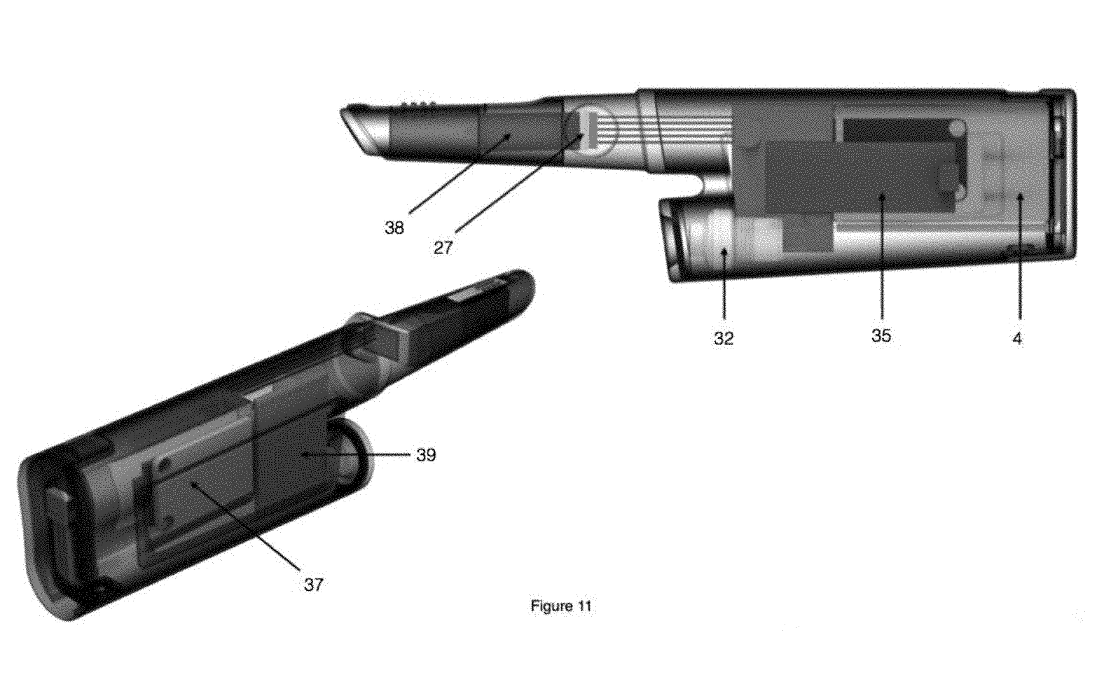

FIGS. 10 and 11 shows a handheld device 23 in the form of a handheld stylus from several different views. The user positions a finger on an end 24 of the stylus on top of a braille cell 26 and a braille cell connector 27. The positions the user's finger while maintaining a grip on a wide body 28 of the stylus with the aid provided from a grip area 30. The handheld device 23 includes a power button 32 that is pressure induced and includes a charging port 34 on the wide body 28. The handheld device 23 further includes a microcontroller 35, a wireless communications module 37, such as a Bluetooth Module, and a DC converter 39. A conductive rubber portion 36 is located adjacent the end 24 where the user's finger is positioned, thereby allowing the handheld device 23 to interact with a touch screen on a touchscreen device. The conductivity may be transferred from the hand of the user while touching metal parts on the handheld device 23 such as the braille cell 26.

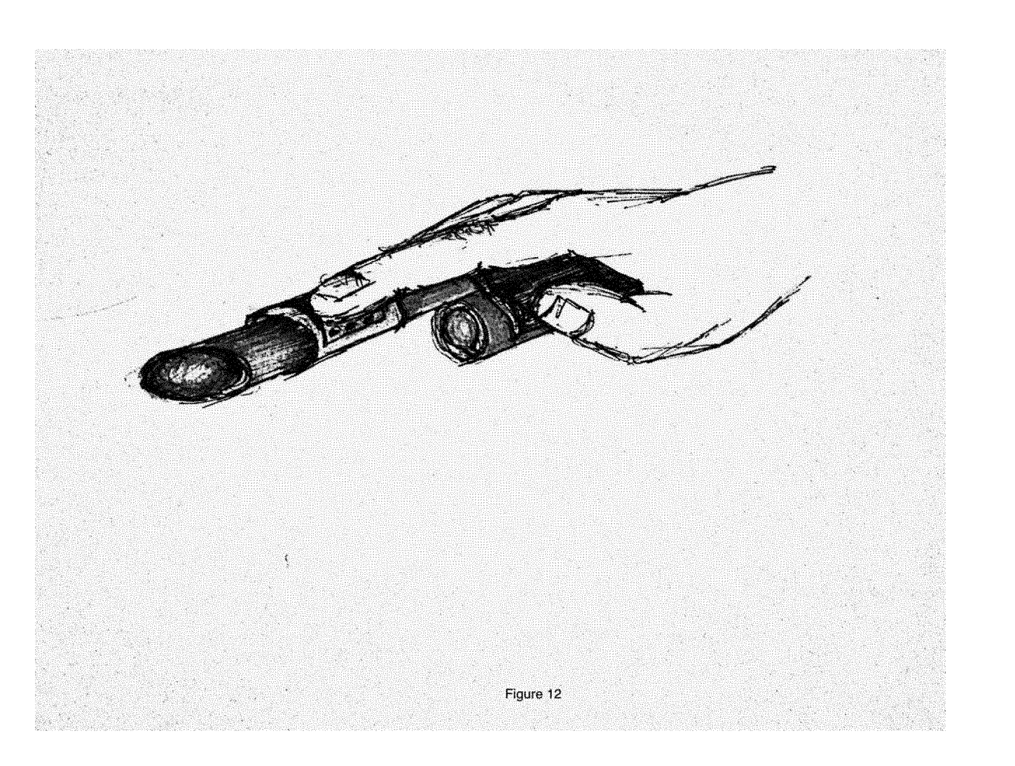

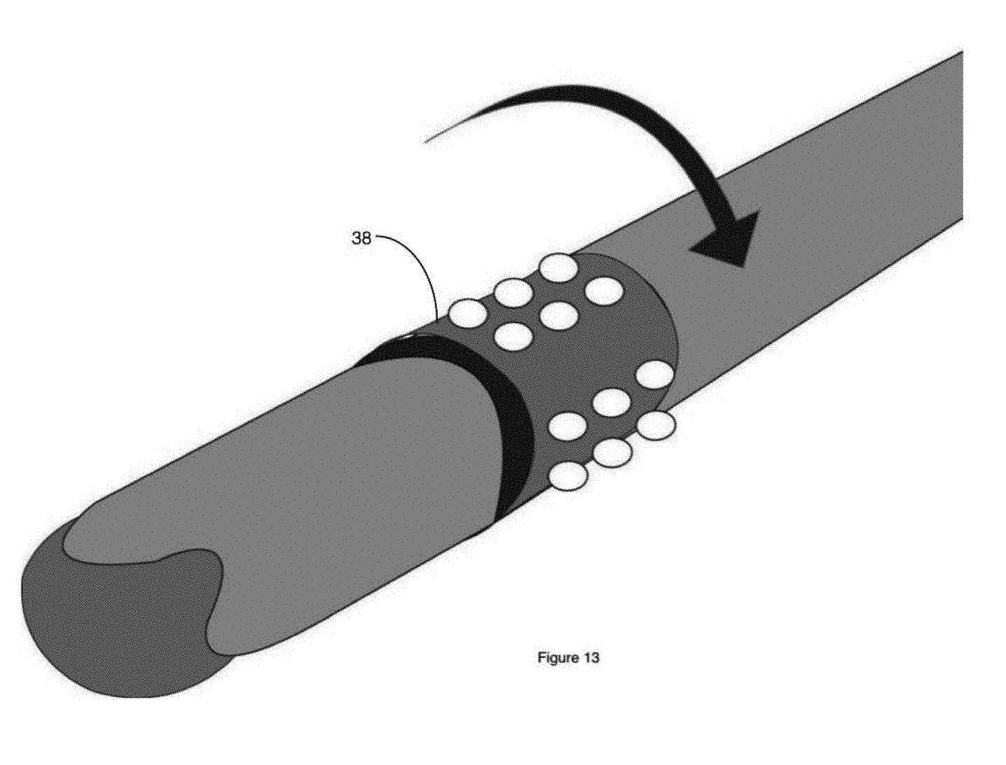

FIGS. 12 and 13 show the concept of a rotating braille cell 38, where the user positions the user's finger on top of the rotating braille cell 38 formed on the device shown in FIGS. 12 and 13 which holds includes a plurality of individual braille cells. The rotating braille cell 38 rotates while the user navigates a touchscreen display with the handheld device 23, thereby allowing the user to experience a natural reading experience as when moving on top of a braille paper.

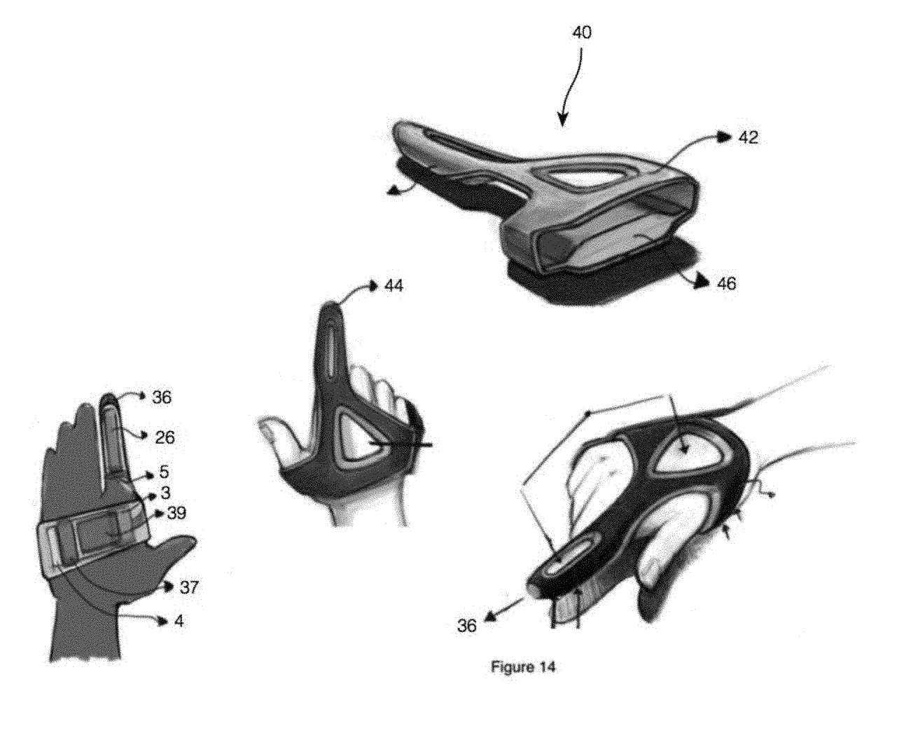

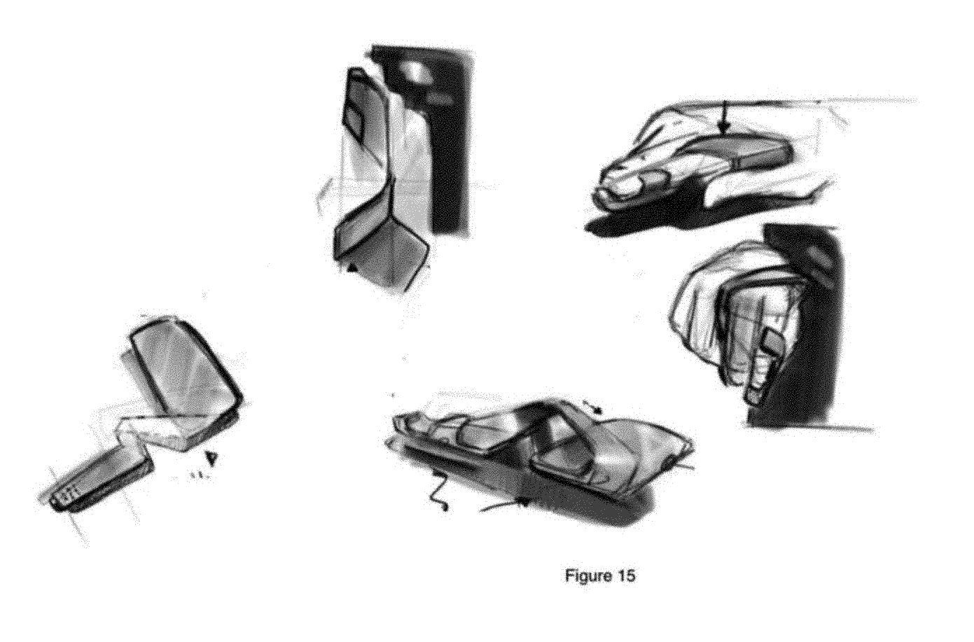

FIGS. 14 and 15 show additional embodiments of a handheld device 40 shaped to fit at least partially onto a hand of a user. The handheld device 40 may include a body 42 made from a flexible material such that the body 42 of the handheld device 40 is wearable on a user's hand. The body 42 extends from a portion that wraps around a user's hand to an end 44 that extends over a user's index finger. The braille cell 2 is located within the body 42 and adjacent to an index finger of the wearer. Components including the microcontroller 3, power source 4, and communications module 37 are preferably located on the body 42. The various electronic compoennts may be located within a pocket 46 formed in the body 42 adjacent to a palm of a user's hand. In the embodiment shown in FIG. 15, the body 42 may be shaped to fit around a finger of the user instead of wrapping fully around the user's hand.

The handheld device 1 is able to detect contents of a display of a touchscreen or other device and to transmit the contents of the display to a user in an order based on movement of the user to simulate directly reading the contents of the display. The touchscreen or other device detects a location of a handheld or semi-wearable device on a display of the device and communicates contents of the display to the handheld or semi-wearable device through physical feedback on the handheld device 1. Contents of the display in the particular location of the handheld device 1 are transmitted to the handheld device 1 and produced as physical feedback on the device, such as through the braille cell 2. The handheld device 1 preferably utilizes wireless communication, such as with a Bluetooth module, to establish communication with the touchscreen device 10. The touchscreen device 10 detects a position of the handheld device 1 on a display of the touchscreen device 10 and transmits data to the handheld device corresponding to content in that position of a display of the touchscreen device 10. A braille library is preferably stored on one of the handheld device 1 and touchscreen device 10 such that content of the display on the touchscreen device 10 is translated to tactile feedback, such as braille, on the braille cell 2 of the handheld device 1. The handheld device 1 may produce additional tactile feedback corresponding to a location of the handheld device 1 on the display of the touchscreen device 10, such as to indicate that the handheld device 1 is at the end of a line of content or adjacent an edge of the display of the touchscreen device 10.

While reference is made herein to tactile feedback of the handheld device 1 provided as braille, it is also understood that the handheld device 1 may provide tactile feedback in various other forms. For example, tactile feedback may be provided as physical representations of characters or images displayed on the touchscreen device 10. Further, additional tactile feedback may be provided, such as vibrations, pulses, or other various tactile outputs generated on the handheld device.

In one embodiment, information of the touchscreen device 10 is automatically transmitted to the handheld device 1 corresponding to notifications or actions on the touchscreen device 10. Notifications or actions include, for example, received text messages, emails, or push notifications occurring on the touchscreen device 10.

In one embodiment, a user may move the handheld device 1 along a surface other than a display of a touchscreen device, such as a table. As the user moves the handheld device 1 on the surface, movement of the handheld device 1 is detected and communicated to a device, such as a personal computer or touchscreen device. The device detects movement of the handheld device 1, such as with a ball or laser located on an end of the handheld device 1, and in response transmits information to the handheld device 1 corresponding to content shown on a display of the device. Alternatively, the handheld device 1 may include an accelerometer such that if a user manipulates the handheld device 1 through the air, the device detects movement of the handheld device 1. In another embodiment, the handheld device 1 includes an optical text recognition scanner (OCR) on an end of the device such that contents of a display are detected and communicated to the user through physical feedback on the handheld device 1.

In one embodiment, an application programming interface (API) is implemented on the touchscreen device 10 to enable the handheld device 1 to be operable with various applications installed on the touchscreen device 10.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A portable device for translation of digital content on a display into tactile feedback, the device comprising:
a conductive material located adjacent an end of the portable device for contacting a display of a touchscreen device;
a microcontroller located on a body of the portable device;
a communications module in electronic communication with the microcontroller; and
a first braille cell comprising a plurality of movable individual braille elements, the individual braille elements collectively capable of forming braille alphabet letters;
wherein the microcontroller receives a command via the communications module to create a braille character on the first braille cell in response to the conductive material contacting the display of the touchscreen device, the braille character corresponding to a character displayed on the display of the touchscreen device at the location the conductive material contacts the display.

2. The portable device for translation of digital content on a display into tactile feedback of claim 1, the device further comprising:
a glove body shaped to conform to a shape of a user's hand, wherein the first braille cell is located at a first fingertip of the glove; and
a second braille cell located at a second fingertip of the glove.

3. The portable device for translation of digital content on a display into tactile feedback of claim 2, the device further comprising:
a first pressure sensor located adjacent the first braille cell; and
a second pressure sensor located adjacent the second braille cell;
wherein the first and second pressure sensors detect when the first and second fingertips of the glove contact a surface.

4. A portable device for translation of digital content on a display into tactile feedback, the portable device comprising:
a glove body shaped to conform to a shape of a user's hand;
a conductive material located adjacent an end of the portable device for contacting a display of a touchscreen device;
a microcontroller located on a body of the portable device;
a communications module in electronic communication with the microcontroller; and
a first braille cell located at a first fingertip of the glove shaped body and comprising a plurality of movable individual braille elements, the individual braille elements collectively capable of forming braille alphabet letters;
wherein the microcontroller receives a command via the communications module to create a braille character on the first braille cell in response to the conductive material contacting the display of the touchscreen device, the braille character corresponding to a character displayed on the display of the touchscreen device at the location the conductive material contacts the display.

5. A method of translating digital content on a display into tactile feedback, the method comprising:
providing a handheld device including a capacitive portion located on an end of the handheld device and a braille cell located on the device adjacent a finger of a user;
providing a touchscreen device including a touchscreen display;
contacting a portion of the touchscreen display with the capacitive portion of the handheld device;
determining on the touchscreen device a location of the portion of the touchscreen display contacted by the capacitive portion of the handheld device;
identifying a character displayed on the touchscreen device in the portion of the touchscreen display contacted by the handheld device;
transmitting an identity of the character identified within the portion of the touchscreen display contacted by the handheld device;
translating the identified character into a braille character;
generating the braille character on the braille cell of the handheld device.
